(19) United States
(12) Patent Application Publication
(10) Pub. No.: US 2026/0072965 A1
(43) Pub. Date: Mar. 12, 2026

(54) CONTROLLED CONTENT DIVERSITY IN RETRIEVAL FOR GENERATIVE SEARCH

(71) Applicant: GOOGLE LLC, Mountain View, CA (US)

(72) Inventors: Krishna Rakeshkumar Shukla, New York, NY (US); Pranesh Srinivasan, Sunnyvale, CA (US); Nitin Gupta, Cupertino, CA (US)

(21) Appl. No.: 18/827,208

(22) Filed: Sep. 6, 2024

(51) Int. Cl. G06F 16/33; G06F 16/383

(52) U.S. Cl. CPC G06F 16/3344; G06F 16/3338; G06F 16/383

(57) ABSTRACT

Implementations relate to techniques for accounting for diversity and/or completeness when generating a long-form natural language response for a search query. Implementations may identify the most relevant passage in a top-ranking documents for the query and then select, from among the most-relevant passages, those passages that meet inclusion criteria, e.g., a minimum relevance to the query, maximizing diversity with other relevant passages, etc. The passages (or portions thereof) that meet the inclusion criteria may be provided with the query to a generative language model, which generates a long-form response to the query. Some implementations may add additional passages to the potential pool of passages, the additional passages identified from top-scoring documents for queries related to the query provided by the user.

### BACKGROUND

Generative search refers to the use of a generative language model to help a search system provide responses to queries. Such language models can provide inaccurate information in response to a query. These inaccuracies can be referred to as hallucinations. To minimize hallucinations, search engines can identify top-ranked documents and provide a few of those top-ranked documents as context for the query.

### SUMMARY

Implementations relate to techniques for accounting for diversity and/or completeness when generating a long-form natural language response for a search query. A long-form response is a response in a natural-language, paragraph form. Long-form responses can provide responses that cover multiple aspects of a query. Diversity ensures that diverse relevant passages from documents responsive to a query are used in constructing the long-form response. Completeness ensures that relevant passages from similar queries are used in constructing the long-form response. To account for diversity, implementations may identify the top-ranking documents for the query and then partition top-ranking documents into passages and identify a passage most-relevant to the query from the document. Implementations may select from among the most-relevant passages those passages that meet inclusion criteria. The inclusion criteria may be that the passage meets a minimum relevance to the query. The inclusion criteria may include maximizing diversity with other relevant passages. The passages that meet the inclusion criteria, or portions of those passages, may be provided with the query to a generative language model and the model may provide the long-form response. To satisfy completeness, implementations may add additional passages to the potential pool of passages selected for inclusion in the prompt context. These additional passages may be identified from top-scoring documents for queries related to the query provided by the user.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example environment in which improved techniques described herein may be implemented.

FIG. 2 is a diagram that illustrates an example long answer generator, according to disclosed implementations.

FIG. 3 is a diagram that illustrates an example relevant resource identifier, according to disclosed implementations.

FIG. 4 is a diagram that illustrates an example method for increasing diversity when generating long-form responses, according to disclosed implementations.

FIG. 5 is a diagram that illustrates another example method for increasing diversity and completeness when generating long-form responses, according to disclosed implementations.

FIG. 6 is a diagram that illustrates an example of a distributed computer device that can be used to implement the described techniques.

### DETAILED DESCRIPTION

Implementations relate to a system that improves the quality of a long-form response to a search query where the response is generated using a language model. Long-form responses are beneficial for search responses for complex queries. Many queries are factual queries, which ask for information about a particular entity, e.g., who was the third US president?, who wrote The Hobbit?, or how tall is the Eiffel Tower? These queries can be answered with a factual statement, e.g., identified in a resource and/or via a fact repository such as a knowledge graph. Complex queries pose questions that cannot be answered directly from a fact repository. Such questions may be asked in a yes/no manner, but the answer is not an attribute/fact about an entity and a full answer would address different aspects and nuances of the query. Some example complex queries include how does where coffee is grown affect the taste?, what are the core arguments of Range by David Epstein?, and Is milk good for you? Answering complex queries requires information extraction from resources that might include relevant information. Currently, search systems identify resources likely relevant to a query and even identify a most relevant portion of the resource for presentation to a user. A few of the most relevant resources (or portions thereof) may be provided to a generative language model, which may produce a long-form answer to the query. Long form responses in a natural language format. Long-form responses can include a paragraph or multiple paragraphs. The length of a long-form response can depend on the complexity of the query for which it is generated.

A technical problem with using top-ranked documents as context for the generative language model is that these documents bias the generated long-form response to content contained within the document. But the few top-ranked documents provided for context often address only one aspect of a complex query. Because of the bias, the long-form response generated using portions of a few top-ranked resources focuses only on one aspect and fails to provide a response that fully answers the query. As an example, the most relevant portions of top-scoring resources responsive to the query is milk good for you? may focus on the benefits of milk, but lack any information on the potential harms of milk. Such a long-form response lacks diversity of relevant information. Similarly, the most relevant portions of top-scoring resources responsive to the query how does where coffee is grown affect taste may relate to South American coffee production. This biases any long-form response generated using the portions as context for the complex query to information about South American locations, which does not represent the diversity of coffee growing locations. Moreover, such a long-form response fails to address all potential aspects of a query. Thus, while current methods reduce hallucinations, these methods lead to lower-quality responses that lack or have lower diversity and lack completeness.

To address the technical problem of improving the diversity and/or completeness in generated long-form responses to a complex query, implementations extract a relevant portion from each of several top-ranked resources and identify a set of those portions that maximize diversity. This can be done by selecting portions that are most dissimilar to already selected portions. Similarity may be determined using known or later developed techniques, including using embedding similarities. In some implementations, only portions that meet a threshold relevance to the query are considered for inclusion in the set. This guarantees that the portions have a minimum relevance to the query. In some implementations, a portion with a highest relevance is added to the set initially. In some implementations, portions may be added as long as they meet a diversity threshold. The diversity threshold may ensure that a portion is not too similar to any other portion already in the set. In some implementations, portions may be added based on having a highest diversity with the portions already in the set. The portions in the set are then provided to the language model with the query for use in generating the long-form response. In some implementations, content of the portions may be extracted (e.g., a few hundred characters) before being provided to the language model. Because the portions in the set maximize diversity, a technical benefit of disclosed techniques is that the long-form response generated by the language model for the query is of higher quality, i.e., has fewer hallucinations while also covering multiple aspects of the complex query.

Some implementations may improve on the diversity of the long-form response by ensuring completeness in addition to diversity in the portions provided to the language model. Implementations may ensure completeness by determining a group of queries related to the complex query issued by the user. The query issued by the user is referred to as the main query. In addition to the diversity set of passages determined for the main query, as described above, implementations may also determine a diversity set of relevant passages for each related query. The diversity set of relevant passages maximizes diversity among the relevant passages, as described above. Implementations may then select a final set, i.e., completeness set, of passages from among these various diversity sets. The selection of passages for the completeness set can consider the weight assigned to the queries. The main query may have a weight higher than any of the related queries and, therefore, may contribute more passages from its diversity set to the completeness set. The related queries may also be assigned weights and may contribute relevant passages to the completeness set from their diversity sets in accordance with the weights assigned. In some implementations, the number of characters extracted from a relevant portion may be determined based on the weight assigned to the query the portion is associated with. Passages may be selected for the completeness set in a manner similar to the one described above, with an initial portion or two being selected from the diversity set for the main query and additional portions being selected based on not being too similar to a portion already selected for the completeness set.

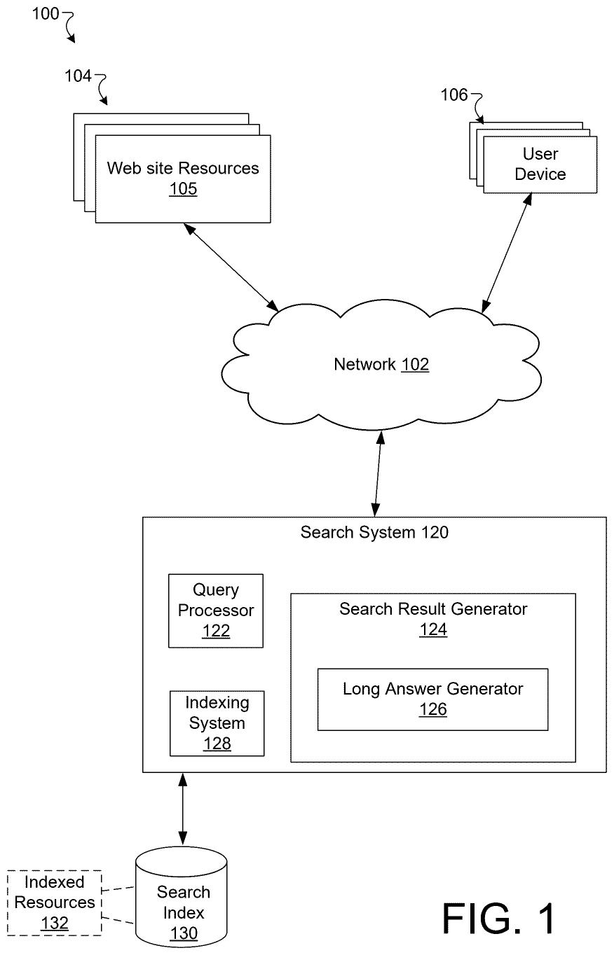

FIG. 1 is a diagram that illustrates an example environment 100 in which improved techniques described herein may be implemented. In the example of FIG. 1, a search result generator 124 of a search system 120 includes (e.g., uses, has access to) an long answer generator 126. In the example of FIG. 1 the search system 120 is described as an Internet search engine, but implementations are not limited to Internet search engines and the disclosed techniques can be applied in any type of search system that responds to queries based on resource content. As used herein, resources can refer to any content accessible to a search engine. Thus, resources include webpages, images, documents, media, etc.

With continued reference to FIG. 1, a search system 120 provides search services. The example environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the web sites 104 and/or the search system 120. In some examples, the search system 120 can access the web site 104 via the Internet. The environment 100 may include millions of web sites 104 and user devices 106. In some implementations, the indexing system 128, query processor 122, and search result generator 124 may be co-located, e.g., at a server, which may be a distributed server. In some implementations, one or more of the indexing system 128, the query processor 122, and/or the search result generator 124 may be remote from but communicatively coupled with each other, e.g., at different servers that communicate with each other.

In some examples, a web site 104 is provided as one or more resources 105 associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. Each web site 104 is maintained by a publisher, e.g., an entity that manages and/or owns the web site. Web site resources 105 can be static or dynamic. In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones, wearable devices, and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart speakers. A user device 106 typically includes a user application, e.g., a web browser, to facilitate the sending and receiving of data over the network 102.

The user device 106 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 106. The set of processing units include one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 105, the search system 120 includes an indexing system 128 identifies the resources 105 by crawling and indexing the resources 105 provided on web sites 104. The indexing system 128 may index data about and content of the resources 105, generating search index 130. In some implementations, the fetched and indexed resources 105 may be stored as indexed resources 132. In some implementations, the search index 130 and/or the indexed resources 132 may be stored at the search system 120. In some implementations, the search index 130 and/or the indexed resources 132 may be accessible by the search system 120. In some implementations (not shown), the search system 120 may have access to a separate fact repository that can be accessed to provide factual responses to a query and/or to help with ranking resources responsive to a query.

The user devices 106 submit search queries to the search system 120. In some examples, a user device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

The search system 120 may include query processor 122 and/or search result generator 124 for responding to queries issued to the search system 120. In response to receiving a search query, the query processor 122 may process (parse) the query and access the search index 130 to identify resources 105 that are relevant to the search query, e.g., have at least a minimum specified relevance score for the search query. Processing the query can include applying natural language processing techniques and/or template comparison to determine a type of the query. The type may be a factual query. The type may be a complex query. The type may be an opinion query. The query type can be determined using query signals employing known or later developed techniques. The degree of complexity, referred to as a complexity score, of an opinion or other complex query can be determined using query signals. In some implementations, machine learning can be used to identify a query as complex and/or provide a complexity score for the query. The resources searched, the ranking applied, and/or the search result elements included in a search result page may be dependent on the type of the query and/or the type of the user device 106 that issued the query.

The search system 120 may identify the resources 132 that are responsive to the query and generate a search result page. The search result page includes search results and can include other content, such as ads, entity (knowledge panels), onebox answers, entity attribute lists (e.g., songs, movie titles, etc.), short answers, generated responses (e.g., from a generative language model), other types of rich results, links to limit the search to a particular resource type (e.g., images, travel, shopping, news, videos, etc.), other suggested searches, etc. Each search result corresponds to a resource available via a network, e.g., via a URL/URI/etc. The resources represented by search results are determined by the search result generator 124 to be top ranked resources that are responsive to the query. In other words, the search result generator 124 applies a ranking algorithm to the resources to determine and order in which to provide search results in the search result page. A search result page may include a subset of search results initially, with additional search results (e.g., for lower-ranked resources) being shown in response to a user selecting a next page of results (e.g., either by selecting a ‘next page’ control or by continuous scrolling, where new search results are generated after a user reaches and end of a currently displayed list but continues to scroll).

Each search result includes a link to a corresponding resource. Put another way, each search result represents/is associated with a resource. The search result can include additional information, such as a title from the resource, a portion of text obtained from the content of the resource (e.g., a snippet), an image associated with the resource, etc., and/or other information relevant to the resource and/or the query, as determined by the search result generator 124 of the search system 120. In some implementations, the search result may include a snippet from the resource and an identifier for the resource. For example, where the query was issued from a device or application that received the user query via voice, the search result may be a snippet that can be presented via a speaker of the user device 106. The search result generator 124 may include a component configured to format the search result page for display or output on a user device 106. The search system 120 returns the search result page to the query requestor. For a query submitted by a user device 106, the search result page is returned to the user device 106 for display, e.g., within a browser, on the user device 106.

In disclosed implementations, the search result generator 124 includes a long answer generator 126. The long answer generator 126 may be used by the search result generator 124 to rank or re-rank resources responsive to a complex query. The search result generator 124 uses the long answer generator 126 to generate a snippet for one or more of the responsive resources. In some implementations, the long answer generator 126 may include an extractive summary model. The extractive summary model may be a machine learned model trained to provide an extractive summary, a score for an extractive summary, or both an extractive summary and a score for the extractive summary given a query and a resource (e.g., the content of the resource), as described herein.

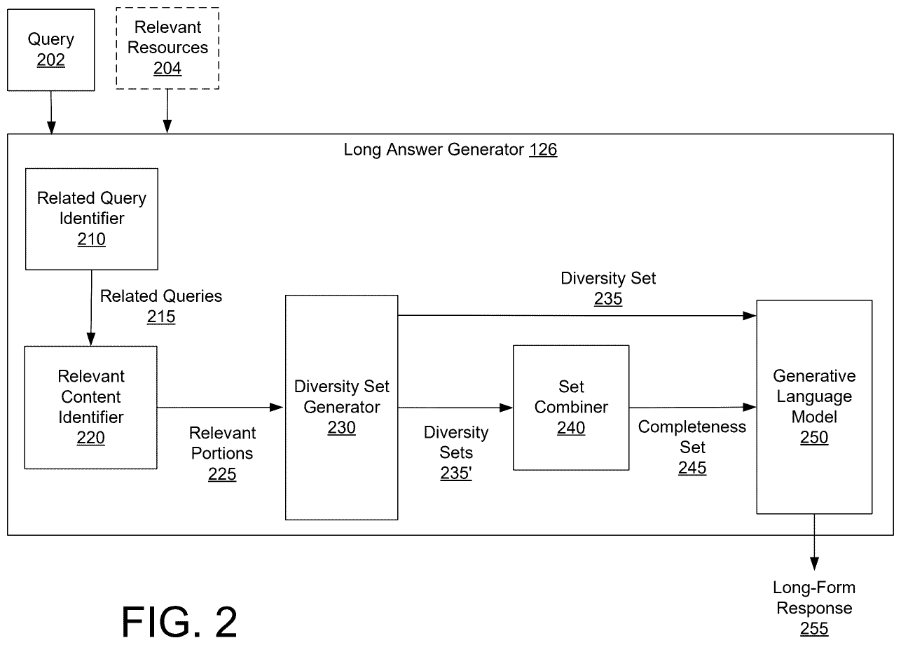

FIG. 2 is a diagram that illustrates an example long answer generator 126, according to disclosed implementations. The long answer generator 126 is configured to generate a long-form response 255 for a query 202. Query 202 is referred to as the main query. Query 202, or main query, is a query submitted by a user or by a requesting process. In some implementations, a search result generator 124 may use the long-form response 255 generated for query 202 in a search result page provided in response to query 202. Thus, the long-form response 255 can be considered a type of rich result for query 202. In some implementations, a portion of the long-form response 255 may be initially provided with the search result page and a remainder of the long-form response 255 may be subsequently provided. In some implementations, the remainder of the long-form response 255 may be provided in response to selection of a control. The control may represent an intent by the user to view the remainder of the response. Such implementations may provide the initial portion to decrease the time between when the query 202 is submitted and when a search result page is generated because generation of the long-form response 255 may take more than a threshold amount of time (e.g., half a second, a second) to completely generate.

The long answer generator 126 operates on a given query 202. In some implementations, the search system 120 may have determined that query 202 is a complex query and may have provided query 202 to the long answer generator 126 in response to this determination. The long answer generator 126 can include related query identifier 210. The related query identifier 210 may be used when query 202 is determined to be a complex query with a complexity score that meets a complexity threshold. The complexity score of the query 202 may be based on query signals using known or later developed techniques, including machine learning and classification techniques. The related query identifier 210 may be configured to identify a group of queries that are related to query 202 (the main query), i.e., related queries 215. The related query identifier 210 may be configured to determine a small number, i.e., quantity, of related queries 215, e.g., less than ten. In some implementations, the related query identifier 210 may identify three to five related queries for the group. In some implementations, the quantity of related queries may be based on the determined complexity score for query 202. For example, more complex queries may have five related queries 215 while a less complex query may have three related queries 215. The number (quantity) of related queries and/or the range of the number of queries can be implementation dependent. The related query identifier 210 may identify related queries based on a balance of relatedness to the main query, i.e., query 202, and diversity from the main query. For example, a related query may need to satisfy a diversity threshold with query 202, or in other words a related query may not be too similar to query 202. The similarity may be based on an embedding similarity. A related query may also need to satisfy a relevance threshold with query 202; in other words, the related query may not be too far from query 202 in the embedding space. Related queries can be generated by a generative model. Related queries can be provided by a service associated with the search system 120. Related queries can be based on historical search information. The use of the related queries 215 is optional in some implementations.

The long answer generator 126 can include relevant content identifier 220. The relevant content identifier 220 is configured to identify portions (sections, paragraphs, passages, sentences, etc.) of resources that are responsive to query 202. The portions identified by the relevant content identifier 220 may be the most relevant portions 225. In some implementations, the resources responsive to query 202 are provided to the long answer generator 126, e.g., from the search system 120, e.g., relevant resources 204. In some implementations, the relevant content identifier 220 may identify the resources relevant to query 202. In some implementations, the relevant content identifier 220 may call a service to identify the resources relevant to query 202.

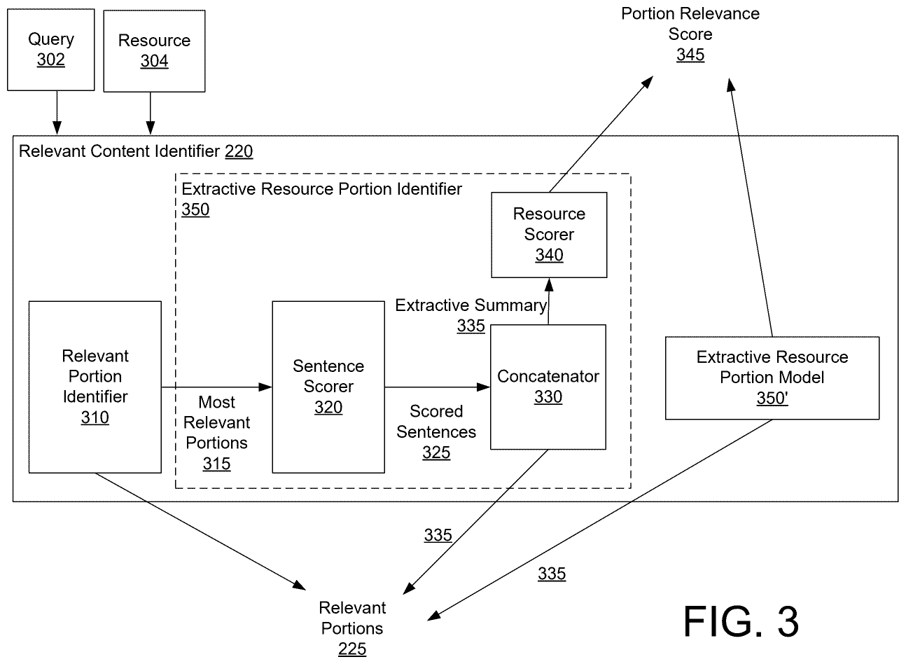

The relevant content identifier 220 may be configured to identify, for at least some of the top-ranked relevant resources, a portion that is most relevant to query 202. The number of top-ranked resources for which the relevant content identifier 220 determines the most relevant portion may be implementation dependent. In some implementations, resources must have a relevance score for query 202 that meets a threshold before the relevant content identifier 220 identifies a relevant portion for the resource. In some implementations, any resource ranked in the top n resources a query may have an extractive summary relevance score calculated by the long answer generator 126. The relevant content identifier 220 may use known or later developed techniques for identifying the relevant portions 225 for query 202. In some implementations, the relevant content identifier 220 may utilize a service of the search system 120 to identify relevant content for a resource. In such implementations, the relevant content identifier 220 may provide the service with the resource identifier of the resource being analyzed and query 202 and may request a number of (e.g., one, two, three, etc.) top relevant portions of each resource. In some implementations, the relevant content identifier 220 may request the entire relevant portion be returned. In some implementations, relevant content identifier 220 may be configured to determine the top relevant portions. FIG. 3 illustrates example operations that can be performed by the relevant content identifier 220 in such implementations. In such implementations, the relevant portion of a reference may be a summary comprised of the most relevant sentences in the resource.

The relevant content identifier 220 may be configured to select one relevant portion for each resource responsive to a query for inclusion in relevant portions 225. The relevant content identifier 220 may be configured to select one relevant portion for some of the resources responsive to the query for inclusion in relevant portions 225. The relevant content identifier 220 may be configured to select more than one relevant portion for highest scoring resources for inclusion in relevant portions 225. This may occur when there is an insufficient number of resources that meet a relevance threshold for the query. Each relevant portion included in relevant portions 225 may have a respective score that represents the passage's relevance to the query, i.e., a portion relevance score. In some implementations, these portion relevance scores may be compared against a relevance threshold before inclusion in the relevant portions 225. Put another way, the relevant content identifier 220 may be configured to exclude (filter out) from relevant portions 225 relevant portions that have a respective score that fails to meet a threshold (e.g., a relevant portion threshold). The relevant portions 225 may include a predetermined number of portions (e.g., twenty, fifty, one hundred, etc., represented by n), for a query regardless of the portion relevance score. In some implementations, the relevant portions 225 may include up to n portions with portion relevance scores that meet the relevant portion threshold.

In implementations that provide related queries 215 to the relevant content identifier 220, the relevant content identifier 220 is configured to determine relevant portions 225 for each query, i.e., for the main query and for each query in related queries 215. Thus, where related queries 215 are provided, the relevant portions 225 are understood to include respective relevant portions 225 for each query.

The relevant content identifier 220 may be configured to convert the portions in the relevant portions 225 to an embedding space, or in other words obtain embeddings for the relevant portions 225. The embedding space enables the system to compare similarity between the portions. In some implementations, the diversity set generator 230 may be configured to obtain the embeddings for the relevant portions 225.

The long answer generator 126 includes a diversity set generator 230. The diversity set generator 230 is configured to select portions from the relevant portions 225 based on relevance to the query 202 and diversity from one another. Put another way, the diversity set generator 230 is configured to identify a diversity set 235 for a query, such as query 202 or any one of queries in the related queries 215. A diversity set 235 includes portions of resources relevant to the query that satisfy inclusion criteria. The inclusion criteria include meeting a portion relevance threshold. Put another way, in order to be selected for diversity set 235, a portion may need a portion relevance score (reflecting relevance to the query) that meets a relevance threshold. In some implementations, the relevant content identifier 220 may ensure that this criterion is met before inclusion of a portion in the relevant portions 225. In some implementations, the diversity set generator 230 may filter out (exclude) portions in the relevant portions 225 that fail to meet the threshold.

For portions that meet the threshold, the diversity set generator 230 may select a portion from the relevant portions 225 that has a highest portion relevance score for inclusion in the diversity set 235. After adding the portion with the highest portion relevance score, the diversity set generator 230 may be configured to add additional portions based on diversity with portions already in the diversity set 235. The diversity set generator 230 may use an embedding space to determine diversity between portions. As indicated above, the diversity set generator 230 or the relevant content identifier 220 may obtain embeddings for portions in the relevant portions 225. The embeddings of different portions may be compared, e.g., using cosine similarity or some other similarity measure, to determine a measure of (degree of) diversity/similarity. In some implementations, the diversity set generator 230 may do comparisons by analyzing portions by decreasing portion relevance scores. Thus, the portion having the next-highest portion relevance score may be compared with the portions already added to the diversity set 235. If the portion is too similar to any of the portions already added to the diversity set 235, the diversity set generator 230 may skip (filter out, discard) that portion and move on to the portion with the next-highest portion relevance score. In some implementations, the diversity set generator 230 may add portions by diversity. In such implementations, distances are computed between portions not in the diversity set and the diversity set and a portion with the largest distance (the maximum diversity) is added to the diversity set. In such implementations, the portion must also meet a minimum relevance to the query. In either case, the inclusion criteria balances relevance and diversity by excluding highly relevant portions that are too similar to portions already in the set 235 in favor of less relevant portions that increase the diversity (are not too similar to portions already in the set 235). In this manner, the set generator 230 maximizes diversity in the set 235.

In some implementations, the inclusion criteria can include domain and/or resource constraints. The domain constraint may limit the number of portions added to the diversity set 235 for resources from the same domain. For example, a domain constraint may limit the number of portions for resources from the same domain to one. Thus, once a portion for a resource is selected, the diversity set generator 230 may not select any portions from resources associated with that domain. In some implementations, the domain constraint may limit the number of portions for resources from the same domain to two. A resource constraint may limit the number of portions from a resource that can be added to the diversity set to a small number, e.g., one, two, or three. Thus, as with the domain constraint, the resource constraint may exclude other portions of a resource from membership in the diversity set 235 once a portion from the resource is selected as a member of the diversity set 235. The diversity set generator 230 may continue adding portions from the relevant portions 225 to the diversity set 235 using the inclusion criteria until the diversity set 235 is full or until no more portions meet the minimum relevance to the query. The diversity set 235 is full when a predetermined number of portions has been selected for the set. In some implementations, the predetermined number of members in a diversity set 235 may be fixed. In some implementations, the predetermined number of members in a diversity set 235 may be based on the complexity of the query, i.e., based on the complexity score for the query. Such implementations may allow a diversity set for more complex queries to have more members. The number of members and/or range of numbers may be small, e.g., three, five, seven, etc.

In implementations where related queries 215 are not used, the diversity set generator 230 may be configured to shorten the portions before they are provided to the generative language model 250. For example, a predetermined number of characters (e.g., 200, 300, 400, 500, etc.) may be extracted from each portion in the diversity set 235 before being provided to the generative language model 250. In some implementations, more characters may be extracted from portions with higher portion relevance scores. In some implementations, the passages are limited to the predetermined number of characters before they are added to the relevant portions 225 and therefore there is no need to shorten the passages.

In implementations where related queries 215 are provided, the diversity set generator 230 may determine a set 235 for the main query (query 202) and for each query in the related queries 215, as described above. These diversity sets are represented, collectively, as diversity sets 235′. In such implementations, the long answer generator 126 can include set combiner 240. The set combiner 240 is configured to select some of the portions from the diversity sets 235′ (e.g., a diversity set 235 for the main query and a respective diversity set 235 for each query in the related queries 215) for a completeness set 245. The completeness set 245 includes some of the portions from the diversity set 235 for the main query (query 202), as well as some portions from at least some of the remaining sets in the diversity sets 235′. The set combiner 240 may assign weights to the queries, with the main query having a highest weight. The weights of the remaining queries may be based on relevance to the main query. For example, queries with a higher relevance to the main query may be assigned higher weights than queries less relevant to the main query. The set combiner 240 may be configured to balance relevance and diversity among the portions selected for the completeness set 245. In some implementations, the set combiner 240 may be configured to shorten the portions before they are provided to the generative language model 250, as described above.

The generative language model 250 is a model that uses artificial intelligence (AI) to understand and generate human language. Generative language model 250 is a class of model that generates realistic conversational responses by estimating the probability of a token or sequence of tokens occurring next in a longer sequence of tokens. Such models can be large, having hundreds of thousands, millions, billions, or even trillions of parameters.

Although illustrated as part of the long answer generator 126 in FIG. 2, as discussed above, one or more components may be separate from the long answer generator 126 but accessible to the long answer generator 126, e.g., via an API call. For example, the long answer generator 126 may use a relevant content identifier 220, a diversity set generator 230, a set combiner 240 or a generative language model 250 that is a service provided by the search system 120. Thus, for example, the relevant content identifier 220 may be used by the search result generator 124 to generate a relevance score that is used to initially rank the resources. Put another way, the long answer generator 126 may use existing processes for certain functions.

FIG. 3 is a diagram that illustrates an example relevant content identifier 220, according to some implementations. In some implementations, the relevant content identifier 220 includes an extractive resource portion identifier 350 and/or an extractive resource portion model 350′. The extractive resource portion identifier 350 and/or the extractive resource portion model 350′ are configured to generate an extractive summary as a relevant portion for a resource 304 and query 302. In some implementations, the relevant portion is provided by the relevant portion identifier 310. The query 302 can be the main query. The query can be a query related to the main query. In some implementations, the relevant content identifier 220 is configured to generate or provide a portion relevance score for the resource and the query.

The relevant content identifier 220 can include relevant portion identifier 310. The relevant portion identifier 310 is configured to identify portions (sections, paragraphs, passages, etc.) of the resource 304 that are most relevant to the query 302. In some implementations, the relevant portion identifier 310 may be a service of the search system 120. In such implementations, the relevant content identifier 220 may provide the service (the relevant portion identifier 310) with the resource identifier of the resource 304 and the query 202 and may request a number of (e.g., two, three, etc.) top relevant portions of each resource 304. In some implementations, the relevant content identifier 220 may request the entire relevant portion be returned. In some implementations, relevant content identifier 220 may be configured to determine the top relevant portions. The relevant portion identifier 310 may use known or later developed techniques for identifying top relevant portions. The relevant portion identifier 310 may assign a relevance score to each portion, i.e., a portion relevance score.

In some implementations, the relevant portion identifier 310 may return the portion with the highest portion relevance score (or the most relevant two or three portions) as the relevant portions 225 for the query 302. In such implementations, the extractive resource portion identifier 350 and/or the extractive resource portion model 350′ are optional (not used).

In some implementations, the relevant content identifier 220 may include extractive resource portion identifier 350. The extractive resource portion identifier 350 may use the portion relevance scores from the relevant portion identifier 310 to determine (identify) the most relevant portions 315 for the resource 304 given the query 302. The most relevant portions 315 may include all portions with a portion relevance score that meets a threshold (e.g., a relevant portion threshold). The most relevant portions 315 may include a predetermined number of portions (e.g., three, four, six, etc., represented by n), regardless of the portion relevance score. In some implementations, the most relevant portions 315 may include up to n portions with portion relevance scores that meet the threshold. In some implementations, the most relevant portions 315 are determined based on parameters the relevant content identifier 220 provides to the extractive resource portion identifier 350.

The extractive resource portion identifier 350 may include a sentence scorer 320. The sentence scorer 320 is configured to determine a sentence relevance score for each portion in the most relevant portions 315. As used herein, a sentence can include any delimited text, such as text that appears in a table row, text that appears in as a list item, etc.

The extractive resource portion identifier 350 may include a concatenator 330. The concatenator 330 is configured to take the scored sentences 325 (which represent sentences in the most relevant portions 315) and generate an extractive summary 335 from the scored sentences 325. The concatenator 330 may use a predetermined number of sentences in generating the extractive summary 335. The concatenator 330 may use any sentence with a sentence relevance score that meets a threshold (e.g., a sentence threshold) to generate the extractive summary 335. The concatenator 330 may use a combination of the predetermined number and the sentence threshold to generate the extractive summary 335. The concatenator 330 may concatenate the sentences of the scored sentences 325 used to generate the extractive summary 335 in the order in which they appear in the resource. Put another way, the sentences are not ordered by sentence relevance score; instead, the concatenator 330 may preserve the order of the sentences in generating the extractive summary 335, which preserves the coherence and information flow of the resource.

In some implementations, the concatenator 330 may determine whether two sentences meet a distance criterion (or criteria). For example, if two sentences appear in different portions, this may meet the distance criterion. As another example, if two sentences are separated by a minimum number of words but appear in the same portion, this may meet the distance criterion. If two sentences that are to be included in the extractive summary 335 meet the distance criterion the concatenator 330 may include an ellipsis between the sentences. For example, if the sentence “In just one year, 1918, the average life expectancy in America plummeted by a dozen years. ” and the sentence “In just 10 days, over 1000 Philadelphians were dead, with another 300,000 sick. ” are top-scoring sentences to be included in the extractive summary 335, when the two sentences appear in the same passage and/or within some minimum number of words of each other, the concatenator 330 may concatenate the sentences as “In just one year, 1918, the average life expectancy in America plummeted by a dozen years. In just 10 days, over 1000 Philadelphians were dead, with another 300,000 sick. ” but may concatenate the sentences with an ellipsis following the first sentence, e.g., as “In just one year, 1918, the average life expectancy in America plummeted by a dozen years. . . . In just 10 days, over 1000 Philadelphians were dead, with another 300,000 sick. ”, when the sentences meet the distance criteria/criterion. In some implementations, the extractive resource portion identifier 350 may provide the extractive summary 335 as one of the relevant portions 225 for the resource 304.

The relevant content identifier 220 may include a resource scorer 340 that is configured to generate a portion relevance score 345 for the extractive summary 335. The resource scorer 340 can be a service operated by the search system 120. In other words, in some implementations, the resource scorer 340 can be called by the extractive resource portion identifier 350 using the query 302 and the extractive summary 335 as input. The resource scorer 340 may consider and score the extractive summary 335 as a single resource (e.g., as a single document). Scoring the relevance of the extractive summary 335 to the query 302 enables the long answer generator 126 to take into account context provided by other passages in the resource, enabling the long answer generator 126 to better (more often and more accurately) identify resources that answer the full complex query. Thus, the relevance score may be used as a portion relevance score 345 in determining which portions to include in a diversity set for a query 302.

Some implementations may include extractive resource portion model 350′ instead of or in addition to the extractive resource portion identifier 350. The

Although illustrated as part of the relevant content identifier 220 in FIG. 3, as discussed above, one or more components may be separate from the relevant content identifier 220 but accessible to the relevant content identifier 220, e.g., via an API call. For example, the relevant content identifier 220 may use a relevant portion identifier 310, a sentence scorer 320, or a resource scorer 340 that is a service provided by the search system 120. Thus, for example, the resource scorer 340 may be used by the search result generator 124 to generate a relevance score that is used to initially rank the resources. Similarly, the relevant portion identifier 310 may be used by the search result generator 124 to identify a most relevant passage to use as a snippet in response to a factual query, etc. Put another way, the relevant content identifier 220 may use existing processes for certain functions. In some implementations, the extractive summary 335 and/or the portion relevance score 345 generated for the query 302 and the resource 304 by the extractive resource portion identifier 350 may be stored as a training example for training/fine tuning extractive resource portion model 350′.

The extractive resource portion model 350′ may be trained to generate the extractive summary 335 and the portion relevance score 345 given a query 302 and a resource 304 (as used herein, reference to a resource is understood to refer to any manner in which a resource's content can be accessed, so giving a resource to a model can include providing the content of the resource or can include providing an identifier of a resource that can be used to access the resource's content). The extractive resource portion model 350′ can provide the relevance score five to ten times faster than the extractive resource portion identifier 350, which helps scale this solution. In an implementation that includes extractive resource portion model 350′, the search system 120 is configured to generate training data from a service similar to extractive resource portion identifier 350. The training data represents extractive summaries 335 and portion relevance scores 345 from queries and resources processed by the extractive resource portion identifier 350. However, the extractive resource portion identifier 350 may be too slow and consume too many computer resources to be done at scale. Accordingly, in some implementations, the extractive resource portion identifier 350 may be used to generate extractive summary 335 and portion relevance score 345 for certain queries and the extractive summaries and relevance scores generated may be saved as training examples to train the extractive resource portion model 350′, which can generate the extractive summary 335 and portion relevance score 345 much faster. In some implementations, the extractive resource portion identifier 350 may be used to respond to every m^{th} query, storing the determined extractive summary 335 and portion relevance score 345 as a training example. The training data can be used to train the extractive resource portion model 350′ to generate an extractive summary 335 to be used as a long-form response 255 for a given query 302 and resource 304.

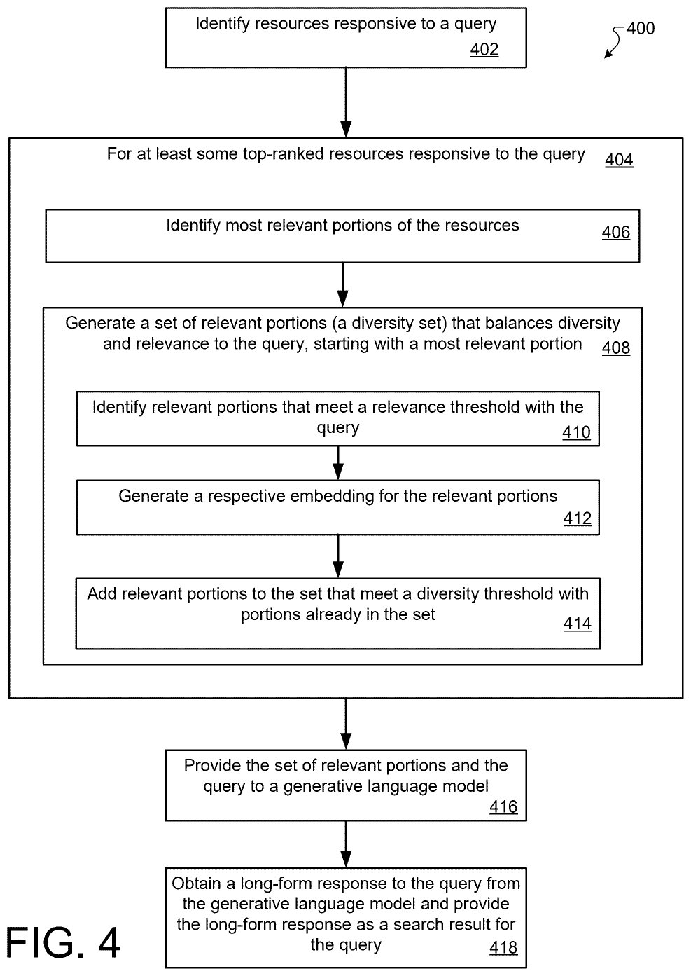

FIG. 4 is a diagram that illustrates an example method 400 for increasing diversity when generating long-form responses, according to disclosed implementations.

Method 400 may be executed in an environment, such as environment 100. In some implementations, one or more of the method steps may be executed by a system, such as long answer generator 126 of FIG. 1. In some implementations, the method 400 is used when a query is determined to be a complex query. Not all steps need to be performed in some implementations. Additionally, the method steps can be performed in an order other than that depicted in FIG. 4.

At step 402, the system identifies (e.g., receives identifiers for) resources determined to be responsive to a query. For at least some of the top-ranked resources, at step 404, the system may generate a set of portions from the responsive resources that balance relevance and diversity of the portions in the set. This set of portions may also be referred to as a diversity set for the query. More specifically, at step 406, the system may identify the most relevant portions of the resources that are responsive to the query. In some implementations, step 406 may be performed independently of step 404. In other words, the most relevant portions may have been identified as part of identifying the resources that are responsive to the query by a search system. In some implementations, the most relevant portions may be extractive summaries of relevant portions. In some implementations, the system may select one relevant portion per resource. In some implementations, the system may select two relevant portions for one or more resources. At step 408, the system may generate a set of relevant portions for the query, i.e., a diversity set for the query. Instead of including the most relevant portions (based on respective relevance scores for the query), the diversity set balances relevance and diversity among the portions represented in the set. Put another way, some portions are included in the diversity set that are less relevant to the query but represent diversity of content from other more relevant portions. This enables a long-form answer to be generated based on relevant but diverse content. The system may include a portion with a highest relevance to the query as the first member of the diversity set.

More specifically, at step 410, the system may determine, from among the most relevant portions, portions that meet a relevance threshold with the query. The threshold may be referred to as a portion relevance threshold. In other words, the system may exclude portions that fail to be similar enough to the query. In some implementations, if an insufficient number of portions meet the relevance threshold, no long-form response may be generated for the query, e.g., method 400 ends. In some implementations, the relevance threshold may be based on the number of responsive documents identified for the query. For example, for a smaller number of relevant resources the system may use a lower relevance threshold and for a larger number of relevant references the system may use a higher relevance threshold. At step 412, the system may generate a respective embedding for the relevant portions. The embedding space enables the system to compare similarity between portions using known or later developed techniques, such as cosine similarity or other such similarity measures. In some implementations, step 412 may be done prior to step 410 and/or as part of identifying relevant portions of the resources (step 406).

At step 414 the system may iteratively add portions to the diversity set based on relevance to the query and diversity from portions already part of the diversity set. In some implementations, the system may analyze the relevant portions in order of decreasing relevance to the query. In such implementations, the system may identify a relevant portion that is not already in the diversity set that has a highest relevance to the query and, if that portion meets a diversity threshold, add that portion to the diversity set. The diversity threshold can be met when the embedding for the portion is not too similar to any one portion already in the set. The diversity threshold can be met when the embedding for the portion is not too similar to an embedding representing a cluster center for the set. In some implementations, the system may analyze the relevant portions in order of increasing diversity. In such implementations, the system may identify a relevant portion that is not already in the diversity set that has a largest distance (embedding distance, measured by the similarity measure) from the portions in the diversity set and add that portion to the diversity set as long as that portion is also not too similar to a portion already in the set and/or too similar to an embedding that represents a cluster center for the portions already in the set.

Step 414 (and thus step 408) may end when a predetermined number of be portions have been added to the diversity set. Step 414 may end when there are no portions to analyze that meet the relevance threshold with the query.

At step 416, the system may provide the query and the diversity set for the query as context for the query to a generative language model. The query may be the prompt for the generative language model. The model may use the diversity set (the portions of the relevant resources selected for the query) as context for generating a long-form response to the query. Because the diversity set balances relevance and diversity, the long-form response will have fewer hallucinations while covering more aspects of the complex query. In some implementations, as part of providing the diversity set as the prompt the system may shorten the portions in the prompt, e.g. by extracting the first n characters of each portion in the diversity set. In some implementations, the portions may be shortened to the first n characters as part of step 406. In some implementations, the portions may be shortened to the first n characters as part of step 408 (e.g., step 414). The number of characters may be an implementation parameter. The number of characters may be dependent on the number of portions represented in the diversity set.

At step 418 the system receives the long-form response to the prompt, i.e., the query, from the generative language model and provides the long-form response, e.g., to the query requestor, as a response to the query. The long-form response may be provided as part of a search result page. In some implementations, the long-form response may be obtained in stages and may be provided in stages. For example, an initial portion may be provided and a remaining portion may be provided if it is requested by the user. Because long-form responses can take a few seconds to generate, providing an initial portion may decrease the time between submission of the query and presentation of the search result page.

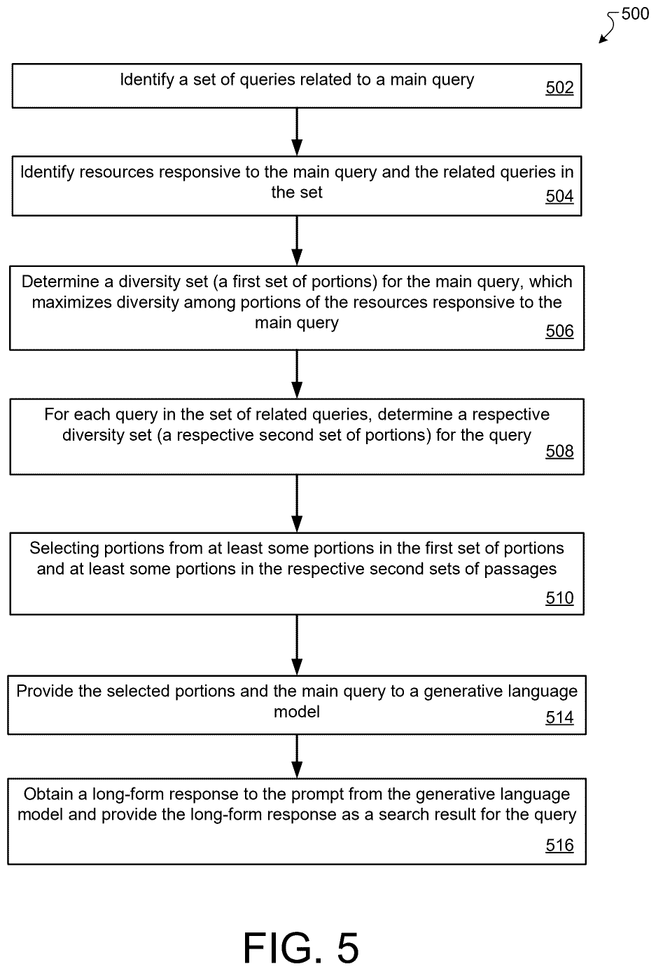

FIG. 5 is a diagram that illustrates another example method 500 for increasing diversity and completeness when generating long-form responses, according to disclosed implementations. Method 500 may be executed in an environment, such as environment 100. In some implementations, one or more of the method steps may be executed by a system, such as long answer generator 126 of FIG. 1. In some implementations, the method 500 is used when a query, i.e., the main query, is determined to be a complex query. In some implementations, method 400 is used when the query has a first degree of complexity and the method 500 is used when the query is determined to have a second degree of complexity, the second degree of complexity being higher than the first degree of complexity. Put another way, method 500 may be used when a complexity score for the query meets a second complexity threshold, which is higher than a first complexity threshold, and the system may use method 400 when the complexity score fails to meet the second complexity threshold but meets a first complexity threshold. Not all steps need to be performed in some implementations. Additionally, the method steps can be performed in an order other than that depicted in FIG. 5.

At step 502, the system receives a main query and identifies a group of queries related to the main query, as described with respect to related query identifier 210 of FIG. 2. At step 504, the system may determine responsive resources for the main query and for each query in the set of queries. Determining the responsive resources for a query is similar to step 402 of FIG. 4. At step 506, the system determines a diversity set for the main query, as discussed with respect to steps 404-414 of FIG. 4. The diversity set for the main query maximizes diversity among the most relevant portions of resources responsive to the main query, balanced against relevance to the query. The diversity set for the main query can be referred to as a first set of portions from highest-ranked resources responsive to the main query. At step 508, for each query in the group of related queries, the system determines a respective diversity set for the query. This is also similar to the operations discussed with respect to steps 404-414 of FIG. 4. The respective diversity set for a query in the set of queries can be referred to as a respective second set of portions from highest-ranked resources responsive to the query.

At step 510, the system generates a completeness set for the main query by selecting portions from at least some portions from the diversity set of the main query and at least some portions from the diversity sets of the related queries. The system may start by including a most relevant portion from the diversity set for the main query. The system may start by including at least one other portion from the diversity set for the main query. The system may then add portions according to a weight assigned to the queries, with the main query having a highest weight and, therefore, contributing more portions to the completeness set. The system may seek to maximize diversity among the portions included in the completeness set. In other words, a portion from a diversity set may not be included in the completeness set if it is too similar (e.g., based on the embeddings) to a portion already in the completeness set. In some implementations, the weight assigned to a related query may determine the number of possible portions that query can contribute to the completeness set.

At step 514, the system may provide the main query and the completeness set for the main query as context for the main query to a generative language model. The main query may be the prompt for the generative language model. The model may use the completeness set (the portions of the relevant resources selected for the main query and for at least some of the related queries) as context for generating a long-form response to the main query. Because the completeness set balances relevance and diversity among multiple related queries, the long-form response will have fewer hallucinations while covering more aspects of the main query. In some implementations, as part of providing the completeness set as the prompt, the system may shorten the portions, as explained with respect to step 416 of FIG. 4.

At step 516 the system receives the long-form response to the prompt, i.e., the main query, from the generative language model and provides the long-form response, e.g., to the query requestor, as a response to the main query. The long-form response may be provided as discussed with respect to step 418 of FIG. 4.

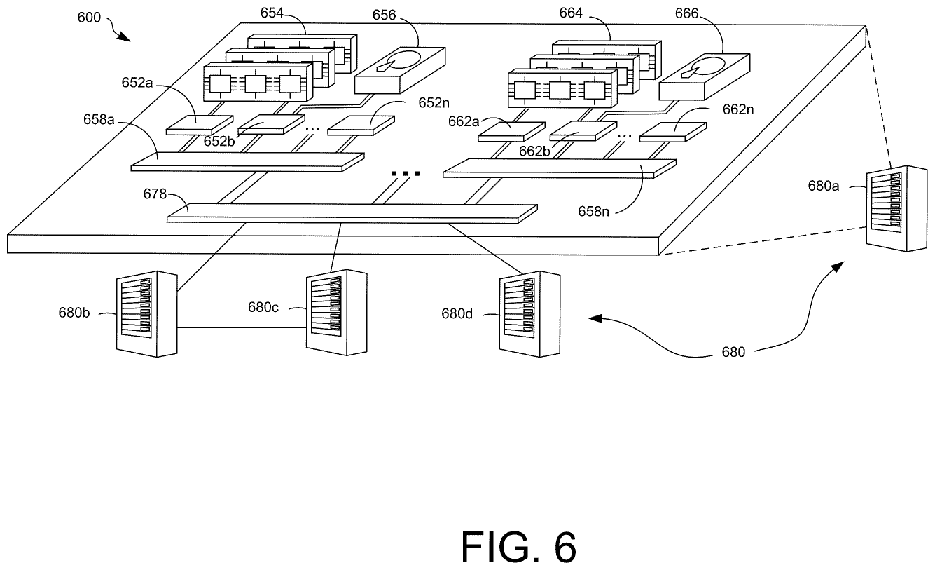

FIG. 6 shows an example of a computing device 600, which may be search system 120 of FIG. 1, which may be used with the techniques described here. Computing device 600 is intended to represent various example forms of large-scale data processing devices, such as servers, blade servers, datacenters, mainframes, and other large-scale computing devices. Computing device 600 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 600 may be a distributed system that includes any number of computing devices 680 (e.g., 680a, 680b, . . . 680n). Computing devices 680 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 680a includes multiple racks (e.g., 658a, 658b, . . . , 658n). Each rack may include one or more processors, such as processors 652a, 652b, . . . , 652n and 662a, 662b, . . . , 662n. The processors may include data processors, network attached storage devices, and other computer-controlled devices. In some implementations, one processor may operate as a master processor and control the scheduling and data distribution tasks.

Processors may be interconnected through one or more rack switches 662a-662n, and one or more racks may be connected through switch 678. Switch 678 may handle communications between multiple connected computing devices 600.

Each rack may include memory, such as memory 654 and memory 664, and storage, such as 656 and 666. Storage 656 and 666 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 656 or 666 may be shared between multiple processors, multiple racks, or multiple computing devices and may include a non-transitory computer-readable medium storing instructions executable by one or more of the processors. Memory 654 and 664 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 654 may also be shared between processors 652a-652n. Data structures, such as an index, may be stored, for example, across storage 656 and memory 654. Computing device 600 may include other components not shown, such as controllers, buses, input/output devices, communications modules, etc.

An entire system may be made up of multiple computing devices 600 communicating with each other. For example, device 680a may communicate with devices 680b, 680c, and 680d, and these may collectively be known as long answer generator 126, search result generator 124, indexing system 128, query processor 122, and/or search system 120. Some of the computing devices may be located geographically close to each other, and others may be located geographically distant. The layout of computing device 600 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) LCD (liquid crystal display), or LED monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity.
Clause 1. A method comprising: determining, for a search query, a group of related queries based on relevance to and diversity from the search query; determining, for the search query, a first set of portions from highest-ranked resources, portions in the first set of portions being selected based on relevance to the search query and diversity from one another; for each related query in the group of related queries, determining a respective second set of portions from highest-ranked resources for the related query, portions in the respective second set of portions being selected based on relevance to the related query and diversity from one another; generating a long-form response for the search query by providing the search query and portions selected from the first set of portions and from the respective second sets of portions to a generative language model; and providing the long-form response as a search result for the search query.
Clause 2. The method of clause 1, wherein a quantity of queries in the group of related queries is based on a complexity score determined for the search query.
Clause 3. The method of any of clause 1 or clause 2, wherein queries in the group of related queries meet a minimum relevance to the search query and maximize diversity within the group.
Clause 4. The method of any of clause 1 to clause 3, wherein the portions in the first set of portions meet a relevance threshold with the search query and maximize diversity within the first set of portions.
Clause 5. The method of any of clause 1 to clause 4, wherein the portions are less than 500 characters.
Clause 6. The method of any of clause 1 to clause 5, wherein each query of the group of related queries has a weight and selecting portions from the respective second set of portions is based on the weights.
Clause 7. The method of any of clause 1 to clause 6, wherein the long-form response includes a plurality of paragraphs.
Clause 8. The method of any of clause 1 to clause 7, wherein the portions in the first set of portions are selected based on resource constraints or a domain constraint.
Clause 9. The method of any of clause 1 to clause 8, wherein determining the respective second set of portions for a particular query from the group of related queries includes: obtaining embeddings of relevant portions of at least some search results for the particular query; selecting a most relevant portion for the second set, the most relevant portion being from a first resource of the search results; from remaining embeddings that are not from the first resource, determining a respective portion from the second set having a largest distance from the most relevant portion, the respective portion meeting a minimum relevance to the search query; and adding the respective portion from the second resource to the second set.
Clause 10. A method comprising: determining, for a query, a set of portions from highest-ranked resources that are responsive to the query, the portions in the set being selected based on relevance to the query and diversity from one another; generating a long-form response for the query by providing the query and portions from the set of portions to a generative language model; and providing the long-form response as a result for the query.
Clause 11. The method of clause 10, wherein determining the set of portions includes: obtaining relevant portions of resources that are responsive to the query; obtaining embeddings of the relevant portions; selecting as a first portion a most relevant portion as a member of the set; and selecting a second portion of the portions as a member of the set, wherein the second portion meets a diversity threshold with the first portion and the second portion meets a relevance threshold with the query.
Clause 12. The method of clause 11, wherein the first portion is from a first resource and other portions from the first resource are excluded from being members of the set.
Clause 13. The method of clause 11 or clause 12, wherein the first portion is from a resource hosted at a domain and other portions from resources hosted at the domain are excluded from being members of the set.
Clause 14. The method of any of clause 11 to clause 13, wherein determining the set of portions includes: selecting a third portion of the portions as a member of the set, wherein the third portion meets a diversity threshold with the first portion and with the second portion and the third portion meets a relevance threshold with the query.
Clause 15. The method of any of clause 11 to clause 13, wherein determining the set of portions includes: selecting a third portion of the portions as a member of the set, wherein the third portion meets a diversity threshold with a cluster center for the set and the third portion meets a relevance threshold with the query.
Clause 16. The method of any of clause 10 to clause 15, wherein the portions are less than 500 characters.
Clause 17. The method of any of clause 10 to clause 16, further comprising: determining that a complexity score for the query meets a complexity threshold, wherein determining the set of portions and generating the long-form response occurs in response to determining that the complexity score meets the complexity threshold.
Clause 18. The method of clause 17, wherein the complexity threshold is a first complexity threshold, the set of portions is a first set of portions, and the method further comprises: determining that the complexity score for the query meets a second complexity threshold, the second complexity threshold being higher than the first complexity threshold; and in response to determining that the complexity score meets the second complexity threshold: determining a group of related queries based on relevance to and diversity from the query, determining, for each related query in the group, a respective second set of portions from highest-ranked resources that are responsive to the related query, the portions in the respective second set being selected based on relevance to the related query and diversity from one another, and generating a completeness set for the query by selecting at least some portions from the first set of portions as members of the completeness set and at least some portions from the respective second sets of portions as members of the completeness set, the portions selected for the completeness set maximizing diversity in the completeness set, wherein generating the long-form response for the query includes providing the query and portions from the completeness set to the generative language model.
Clause 19. A system comprising at least one processor and memory storing instructions that, when executed by the at least one processor, causes the system to perform the method of any of clause 1 to clause 18.
Clause 20. A non-transitory computer-readable medium storing instructions that, when executed by at least one processor, causes a computing device to perform the method of any of clause 1 to clause 18.

What is claimed is:

1. A method comprising:
determining, for a search query, a group of related queries based on relevance to and diversity from the search query;
determining, for the search query, a first set of portions from highest-ranked resources, portions in the first set of portions being selected based on relevance to the search query and diversity from one another;
for each related query in the group of related queries, determining a respective second set of portions from highest-ranked resources for the related query, portions in the respective second set of portions being selected based on relevance to the related query and diversity from one another;
generating a long-form response for the search query by providing the search query and portions selected from the first set of portions and from the respective second sets of portions to a generative language model; and
providing the long-form response as a search result for the search query.

2. The method of claim 1, wherein a quantity of queries in the group of related queries is based on a complexity score determined for the search query.

3. The method of claim 1, wherein queries in the group of related queries meet a minimum relevance to the search query and maximize diversity within the group.

4. The method of claim 1, wherein the portions in the first set of portions meet a relevance threshold with the search query and maximize diversity within the first set of portions.

5. The method of claim 1, wherein the portions are less than 500 characters.

6. The method of claim 1, wherein each query of the group of related queries has a weight and selecting portions from the respective second set of portions is based on the weights.

7. The method of claim 1, wherein the long-form response includes a plurality of paragraphs.

8. The method of claim 1, wherein the portions in the first set of portions are selected based on resource constraints or a domain constraint.

9. The method of claim 1, wherein determining the respective second set of portions for a particular query from the group of related queries includes:
obtaining embeddings of relevant portions of at least some search results for the particular query;
selecting a most relevant portion for the second set, the most relevant portion being from a first resource of the search results;
from remaining embeddings that are not from the first resource, determining a respective portion from the second set having a largest distance from the most relevant portion, the respective portion meeting a minimum relevance to the search query; and
adding the respective portion from the second resource to the second set.

10. A method comprising:
determining, for a query, a set of portions from highest-ranked resources that are responsive to the query, the portions in the set being selected based on relevance to the query and diversity from one another;
generating a long-form response for the query by providing the query and portions from the set of portions to a generative language model; and
providing the long-form response as a result for the query.

11. The method of claim 10, wherein determining the set of portions includes:
obtaining relevant portions of resources that are responsive to the query;
obtaining embeddings of the relevant portions;
selecting as a first portion a most relevant portion as a member of the set; and
selecting a second portion of the portions as a member of the set, wherein the second portion meets a diversity threshold with the first portion and the second portion meets a relevance threshold with the query.

12. The method of claim 11, wherein the first portion is from a first resource and other portions from the first resource are excluded from being members of the set.

13. The method of claim 11, wherein the first portion is from a resource hosted at a domain and other portions from resources hosted at the domain are excluded from being members of the set.

14. The method of claim 11, wherein determining the set of portions includes:
selecting a third portion of the portions as a member of the set, wherein the third portion meets a diversity threshold with the first portion and with the second portion and the third portion meets a relevance threshold with the query.

15. The method of claim 11, wherein determining the set of portions includes:
selecting a third portion of the portions as a member of the set, wherein the third portion meets a diversity threshold with a cluster center for the set and the third portion meets a relevance threshold with the query.

16. The method of claim 10, wherein the portions are less than 500 characters.

17. The method of claim 10, further comprising:
determining that a complexity score for the query meets a complexity threshold,
wherein determining the set of portions and generating the long-form response occurs in response to determining that the complexity score meets the complexity threshold.

18. The method of claim 17, wherein the complexity threshold is a first complexity threshold, the set of portions is a first set of portions, and the method further comprises:
determining that the complexity score for the query meets a second complexity threshold, the second complexity threshold being higher than the first complexity threshold; and
in response to determining that the complexity score meets the second complexity threshold:
determining a group of related queries based on relevance to and diversity from the query,
determining, for each related query in the group, a respective second set of portions from highest-ranked resources that are responsive to the related query, the portions in the respective second set being selected based on relevance to the related query and diversity from one another, and
generating a completeness set for the query by selecting at least some portions from the first set of portions as members of the completeness set and at least some portions from the respective second sets of portions as members of the completeness set, the portions selected for the completeness set maximizing diversity in the completeness set,
wherein generating the long-form response for the query includes providing the query and portions from the completeness set to the generative language model.

19. A system comprising:
at least one processor; and
memory storing instructions that, when executed by the at least one processor, causes the system to perform operations including:
determining, for a search query, a group of related queries based on relevance to and diversity from the search query;
determining, for the search query, a first set of portions from highest-ranked resources, portions in the first set of portions being selected based on relevance to the search query and diversity from one another;
for each related query in the group of related queries, determining a respective second set of portions from highest-ranked resources for the related query, portions in the respective second set of portions being selected based on relevance to the related query and diversity from one another;
generating a long-form response for the search query by providing the search query and portions selected from the first set of portions and from the respective second sets of portions to a generative language model; and
providing the long-form response as a search result for the search query.

20. The system of claim 19, wherein each query of the group of related queries has a weight and selecting portions from the respective second set of portions is based on the weights.
